(19) United States
(12) Patent Application Publication
(10) Pub. No.: US 2026/0279379 A1
(43) Pub. Date: Sep. 17, 2026

(54) AUDIO PROCESSING METHOD AND AUDIO PROCESSING SYSTEM

(71) Applicant: Yamaha Corporation, Hamamatsu (JP)

(72) Inventors: Masato ESASHI, Hamamatsu (JP); Takashi ITO, Hamamatsu (JP); Akihiro TOKUMASU, Hamamatsu (JP); Toru KITAYAMA, Hamamatsu (JP)

(21) Appl. No.: 19/564,533

(22) Filed: Mar. 12, 2026

(30) Foreign Application Priority Data
Mar. 13, 2025 (JP) 2025-040036

(51) Int. Cl. G10L 21/04; G06F 9/445

(52) U.S. Cl. CPC G10L 21/04; G06F 9/44526

(57) ABSTRACT

An audio processing method that is realized by a computer system includes acquiring, from an audio data input unit, audio data without going through an audio processing software, performing an extension processing on the audio data that have been acquired, and outputting the audio data on which the extension processing has been performed, for a processing by the audio processing software. The acquiring, the performing of the extension processing, and the outputting are performed by executing an audio processing plug-in configured to extend a function of the audio processing software.

### CROSS-REFERENCE TO RELATED APPLICATIONS

This application claims priority to Japanese Patent Application No. 2025-040036, filed on March 13, 2025. The entire disclosure of Japanese Patent Application No. 2025-040036 is hereby incorporated herein by reference.

### BACKGROUND

### Technical Field

This disclosure generally relates to a technique for processing audio data.

### Background Information

Various techniques for processing audio data have been proposed in the prior art. For example, Japanese published unexamined application No. 2023-129639 discloses a technique for using a plug-in to extend the functions of a host application, such as a digital audio workstation (DAW).

### SUMMARY

In the prior art, the supply source or the output destination of audio data is limited to an audio interface that is compatible with the host application. In consideration of such circumstances, an object of one aspect of this disclosure is to relax restrictions relating to combinations of audio processing software and supply sources or output destinations of audio data.

In order to solve the problem described above, an audio processing method according to one aspect of this disclosure is realized by a computer system and includes acquiring, from an audio data input unit, audio data without going through an audio processing software, performing an extension processing on the audio data that have been acquired, and outputting the audio data on which the extension processing has been performed, for a processing by the audio processing software. The acquiring, the performing of the extension processing, and the outputting are performed by executing an audio processing plug-in configured to extend a function of the audio processing software.

An audio processing method according to another aspect of this disclosure is realized by a computer system and includes acquiring audio data from an audio processing software, performing an extension processing on the audio data that have been acquired, and outputting the audio data on which the extension processing has been performed to an audio data output unit without going through the audio processing software. The acquiring, the performing of the extension processing, and the outputting are performed by executing an audio processing plug-in configured to extend a function of the audio processing software.

An audio processing system includes an electronic controller including one or a plurality of processors, and the electronic controller is configured to, by executing an audio processing plug-in configured to extend a function of an audio processing software, acquire, from an audio data input unit, audio data without going through the audio processing software, perform an extension processing on the audio data that have been acquired, and output the audio data on which the extension processing has been performed, for a processing by the audio processing software.

An audio processing system includes an electronic controller including one or a plurality of processors, and the electronic controller is configured to, by executing an audio processing plug-in configured to extend a function of an audio processing software, acquire audio data from the audio processing software, perform an extension processing on the audio data that have been acquired, and output the audio data on which the extension processing has been performed to an audio data output unit without going through the audio processing software.

### BRIEF DESCRIPTION OF THE DRAWINGS

FIG. 1 is a block diagram showing a configuration of an audio processing system according to a first embodiment.

FIG. 2 is a block diagram showing a functional configuration of the audio processing system.

FIG. 3 is a flowchart showing a procedure of a process executed by an extension processing unit.

FIG. 4 is a block diagram showing the functional configuration of an audio processing system according to a second embodiment.

FIG. 5 is a block diagram showing a functional configuration of an audio processing system according to a modified example.

### DETAILED DESCRIPTION OF THE EMBODIMENTS

Selected embodiments will now be explained with reference to the drawings. It will be apparent to those skilled in the field from this disclosure that the following descriptions of the embodiments are provided for illustration only and not for the purpose of limiting this disclosure as defined by the appended claims and their equivalents.

### A: First Embodiment

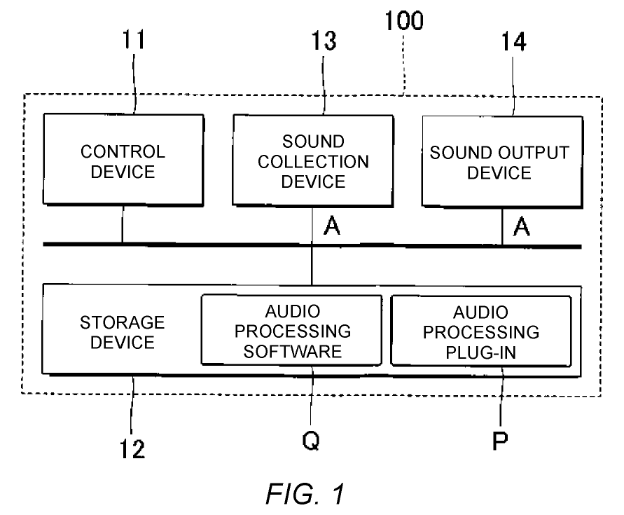

FIG. 1 is a block diagram showing a configuration of an audio processing system 100 according to a first embodiment. The audio processing system 100 is a computer system for processing audio data A. The audio data A are digital data representing given sounds. Examples of the audio data A are digital data representing any type of sound, such as musical sounds (for example, performance sounds or singing sounds of a musical piece), sound effects, natural sounds (environmental sounds), and voice. The audio data A can be in any format.

The audio processing system 100 includes a control device (electronic controller) 11, a storage device 12, a sound collection device 13, and a sound output device 14. The audio processing system 100 is realized by an information device such as a smartphone, a tablet terminal, or a personal computer. The audio processing system 100 can be realized as a single device, or as a plurality of devices which are separately configured.

The control device 11 includes one or more processors that control each element of the audio processing system 100. For example, the control device 11 includes one or more types of processors, such as a CPU (Central Processing Unit), a GPU (Graphics Processing Unit), an SPU (Sound Processing Unit), a DSP (Digital Signal Processor), an FPGA (Field Programmable Gate Array), an ASIC (Application Specific Integrated Circuit), etc.

The storage device 12 includes one or more memory units (one or more computer memories) for storing a program that is executed by the control device 11 and various data that are used by the control device 11. The storage device 12 includes a storage medium, such as a magnetic storage medium or a semiconductor storage medium. The storage device 12 can include a combination of a plurality of types of storage media. A portable storage medium that is attached to/detached from the audio processing system 100, or a storage medium (for example, cloud storage) that the control device 11 can read from or write to via a communication network can also be used as the storage device 12.

The storage device 12 stores an audio processing software Q and an audio processing plug-in P. The audio processing software Q is a basic digital audio workstation (DAW) software for music production. On the other hand, the audio processing plug-in P is additional or auxiliary software for extending one or more functions of the audio processing software Q. An example of the audio processing plug-in P is a VST (Virtual Studio Technology) plug-in ("VST" is a registered trademark). The audio processing plug-in P is provided separately from the audio processing software Q. The audio processing plug-in P is not limited to a VST plug-in. For example, an AU (Audio Units) plug-in or an AAX (Avid Audio Extension) plug-in can be used as the audio processing plug-in P.

The sound collection device 13 is an input device for generating the audio data A. For example, the sound collection device 13 includes one or more microphones that collect sounds to generate analog audio signals, an amplifier that amplifies the audio signals, and an A/D converter that converts the amplified audio signals to digital audio data A. The sound collection device 13 is, for example, a built-in microphone installed in the audio processing system 100, or an external microphone (for example, a USB (Universal Serial Bus) microphone) that is connected to the audio processing system 100 by wire or wirelessly.

The sound output device 14 is an output device that reproduces sounds represented by the audio data A. For example, the sound output device 14 includes a D/A converter that converts the digital audio data A to analog audio signals, an amplifier that amplifies the audio signals, and one or more speakers that emit sounds represented by the amplified audio signals. The sound output device 14 is, for example, a built-in speaker installed in the audio processing system 100, or an external speaker (for example, a USB (Universal Serial Bus) speaker) that is connected to the audio processing system 100 by wire or wirelessly. Headphones or earphones mounted on the ears of a user can be used as the sound output device 14.

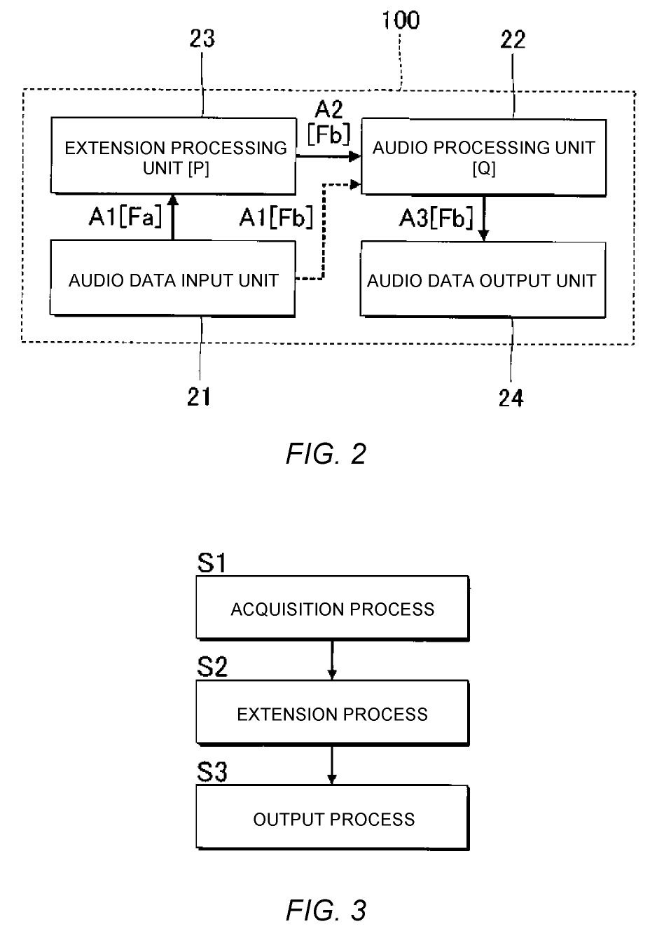

FIG. 2 is a block diagram showing a functional configuration of the audio processing system 100. In the following description, the audio data A in different stages can be distinguished by additional characters (A1, A2, A3) added to the reference symbol of the audio data A.

An audio data input unit 21 of FIG. 2 is a given audio interface that serves as a supply source of the audio data A1. For example, the above-mentioned sound collection device 13 is used as the audio data input unit 21. The audio data A1 supplied from the audio data input unit 21 are digital data sampled at a sampling rate Fa. For example, the A/D converter constituting the sound collection device 13 operates at the sampling rate Fa.

The control device 11 executes a program stored in the storage device 12 to function as an audio processing unit 22 and an extension processing unit 23. The audio processing unit 22 is realized by the control device 11 executing the audio processing software Q. The extension processing unit 23 is realized by the control device 11 executing the audio processing plug-in P. For example, a host function (such as a VST host) included in the audio processing software Q manages the reading and execution of the audio processing plug-in P.

The audio processing unit 22 executes various types of audio processing on audio data A2. The audio processing executed by the audio processing unit 22 includes, for example, an effect imparting process for imparting various audio effects (for example, reverb, delay, equalizer, compressor, etc.) on the audio data A2, a mixing process for mixing a plurality of pieces of the audio data A2 at a given ratio, a mastering process for realizing final adjustments, and a recording process for recording the audio data A2.

The audio data A2 that can be processed by the audio processing unit 22 are digital data with a sampling rate Fb. That is, the sampling rate Fa of the audio data A1 supplied from the audio data input unit 21 is different from the sampling rate Fb of the audio data A2 that can be processed by the audio processing unit 22.

The extension processing unit 23 executes various types of audio processing (hereinafter referred to as "extension process S2") on the audio data A1 to generate the audio data A2. The extension process S2 is a conversion process (SRC: sampling rate converter) that converts the sampling rate of the audio data A1. Specifically, the extension processing unit 23 converts the audio data A1 with the sampling rate Fa supplied from the audio data input unit 21 to the audio data A2 with the sampling rate Fb that can be processed by the audio processing unit 22.

The audio processing unit 22 executes the above-mentioned various types of audio processing on the audio data A2 that have been processed by the extension processing unit 23, thereby generating audio data A3. The audio data A3 are digital data with the sampling rate Fb that can be processed by the audio processing unit 22.

An audio data output unit 24 is a given audio interface that serves as the output destination for the audio data A3. For example, the above-mentioned sound output device 14 is used as the audio data output unit 24. Specifically, the audio data output unit 24 reproduces sounds represented by the audio data A3. The audio data output unit 24 can output the audio data A3 with the sampling rate Fb after being processed by the audio processing unit 22. For example, a D/A converter constituting the sound output device 14 operates at the sampling rate Fb.

If the audio data A1 with the sampling rate Fb are supplied from the audio data input unit 21, the audio data A1 are supplied to the audio processing unit 22 bypassing (i.e., without going through) the extension processing unit 23, as indicated by the dashed arrow in FIG. 2. The audio processing unit 22 executes audio processing on the audio data A1 to generate the audio data A3. As described above, the audio data input unit 21 in the first embodiment can be compatible with either the sampling rate Fa or the sampling rate Fb.

FIG. 3 is a flowchart showing the operation of the extension processing unit 23. The extension processing unit 23 sequentially executes the acquisition process S1, the extension process S2, and the output process S3. That is, in the first embodiment, the audio processing plug-in P executes the acquisition process S1, the extension process S2, and the output process S3.

The acquisition process S1 is a process for acquiring, from the audio data input unit 21, the audio data A1 bypassing (i.e., without going through) the audio processing unit 22 (audio processing software Q). Specifically, the extension processing unit 23 directly acquires the audio data A1 from the audio data input unit 21.

The extension process S2 is a process for processing the audio data A1 acquired by the acquisition process S1 to generate the audio data A2. As described above, the extension process S2 of the first embodiment includes a conversion process for converting the audio data A1 with the sampling rate Fa acquired by the acquisition process S1 to the audio data A2 with the sampling rate Fb. As described above, according to the first embodiment, the audio data A1 with the sampling rate Fa compatible with the audio data input unit 21 can be converted to the audio data A2 with the sampling rate Fb compatible with the audio processing software Q.

The output process S3 is a process for outputting the audio data A2 after the extension process S2 for the audio processing carried out by the audio processing unit 22 (audio processing software Q). The audio processing unit 22 generates the audio data A3 from the audio data A2 output by the output process S3.

As described above, in the first embodiment, the acquisition process S1 for acquiring the audio data A1 bypassing (i.e., without going through) the audio processing software Q, the extension process S2 for processing the audio data A1 acquired by the acquisition process S1, and the output process S3 for outputting the audio data A2 after the extension process S2 to the audio processing unit 22 (audio processing software Q), are realized by the audio processing plug-in P that extends the one or more functions of the audio processing software Q. Accordingly, the audio data input unit 21 in the first embodiment is not limited to an interface that is compatible with the audio processing software Q. For example, the audio data input unit 21 is not limited to an interface that can supply the audio data A with the sampling rate Fb compatible with the audio processing software Q. As described above, according to the first embodiment, it is possible to relax the restrictions on the combination of the audio processing software Q and the audio data input unit 21. In addition, as a result of diversification of the combinations of the audio processing software Q and the audio data input unit 21, it is possible to increase the amount of freedom of the combinations (routing) of audio processing realized by the audio processing software Q.

In addition, according to the first embodiment, it is not necessary to install in the audio processing software Q a program code relating to the acquisition (input process) of the audio data A1. In the configuration described above, for example, the audio processing plug-in P can be shared across a plurality of different pieces of the audio processing software Q. That is, for example, when developing new audio processing software Q, it is not necessary to create a program code for the portion relating to the acquisition (input process) of the audio data A1. Accordingly, compared to a case in which it is necessary to create a new program code for the portion pertaining to the acquisition of the audio data A1, it is possible to increase the efficiency of development of the audio processing software Q.

### B: Second Embodiment

The second embodiment of this disclosure will be described. In each of the embodiments illustrated below, elements that have the same functions as those in the first embodiment have been assigned the same reference symbols used to describe the first embodiment and detailed descriptions thereof have been appropriately omitted.

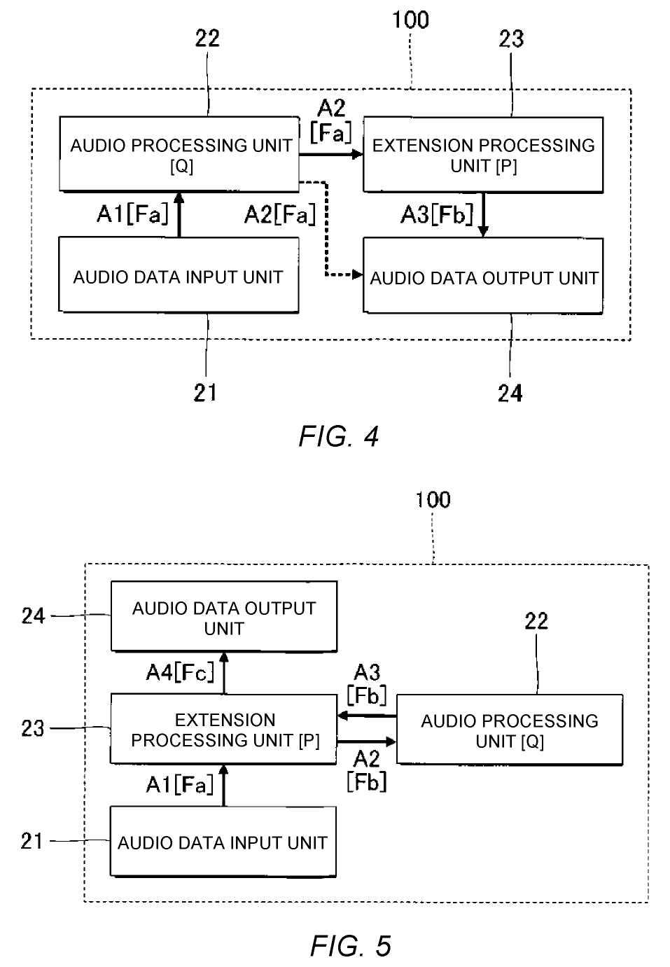

FIG. 4 is a block diagram showing the functional configuration of an audio processing system 100 according to the second embodiment. The audio data input unit 21 supplies the audio data A1 with the sampling rate Fa, in the same manner as in the first embodiment.

The control device 11 executes the audio processing software Q, thereby functioning as the audio processing unit 22, in the same manner as in the first embodiment. The audio processing unit 22 executes various types of audio processing exemplified in the first embodiment on the audio data A1, thereby generating the audio data A2 with the sampling rate Fa. That is, the audio processing unit 22 of the second embodiment processes the audio data A1 with the sampling rate Fa.

The audio data output unit 24 of the second embodiment can output the audio data A3 with the sampling rate Fb. That is, in the second embodiment, the sampling rate Fa of the audio data A2 after the audio processing by the audio processing unit 22 is different from the sampling rate Fb of the audio data A3 that can be output by the audio data output unit 24.

The control device 11 functions as the extension processing unit 23 by the audio processing plug-in P, in the same manner as in the first embodiment. The extension process executed by the extension processing unit 23 is a process that converts the audio data A2 with the sampling rate Fa supplied from the audio processing unit 22 to the audio data A3 with the sampling rate Fb that can be output by the audio data output unit 24.

When the audio data output unit 24 outputs the audio data A2 with the sampling rate Fa, the audio data A2 are supplied to the audio data output unit 24 bypassing (i.e., without going through) the extension processing unit 23, as indicated by the dashed arrow in FIG. 4. As described above, the audio data output unit 24 in the second embodiment can be compatible with either the sampling rate Fa or the sampling rate Fb.

The extension processing unit 23 sequentially executes the acquisition process S1, the extension process S2, and the output process S3, in the same manner as in the first embodiment. That is, in the second embodiment, the audio processing plug-in P executes the acquisition process S1, the extension process S2, and the output process S3, in the same manner as in the first embodiment.

The acquisition process S1 is a process for acquiring the audio data A2 from the audio processing unit 22. The extension process S2 is a process for processing the audio data A2 acquired by the acquisition process S1 to generate the audio data A3. The extension process S2 of the second embodiment includes a conversion process for converting the audio data A2 with the sampling rate Fa acquired by the acquisition process S1 to the audio data A3 with the sampling rate Fb. As described above, according to the second embodiment, the audio data A2 with the sampling rate Fa compatible with the audio processing software Q can be converted to the audio data A3 with the sampling rate Fb compatible with the audio data output unit 24.

The output process S3 is a process for outputting the audio data A3 after the extension process S2 to the audio data output unit 24 bypassing (i.e., without going through) the audio processing unit 22 (audio processing software Q). That is, the extension processing unit 23 directly outputs the audio data A3 to the audio data output unit 24.

As described above, in the second embodiment, the acquisition process S1 for acquiring the audio data A2 from the audio processing software Q, the extension process S2 for processing the audio data A2 acquired by the acquisition process S1, and the output process S3 for outputting the audio data A3 after the extension process S2 to the audio data output unit 24 bypassing (i.e., without going through) the audio processing software Q, are realized by the audio processing plug-in P that extends the one or more functions of the audio processing software Q. Accordingly, the audio data output unit 24 in the second embodiment is not limited to an interface that is compatible with the audio processing software Q. For example, the audio data output unit 24 is not limited to an interface that can output the audio data A with the sampling rate Fa compatible with the audio processing software Q. As described above, according to the second embodiment, it is possible to relax the restrictions on the combination of the audio processing software Q and the audio data output unit 24. Then, as a result of diversification of the combinations of the audio processing software Q and the audio data output unit 24, it is possible to increase the amount of freedom of the combinations (routing) of audio processing realized by the audio processing software Q.

In addition, according to the second embodiment, it is not necessary to install in the audio processing software Q a program code relating to the output (output process) of the audio data A3. In the configuration described above, for example, the audio processing plug-in P can be shared across a plurality of different pieces of the audio processing software Q. That is, for example, when developing new audio processing software Q, it is not necessary to create a program code for the portion relating to the output (output process) of the audio data A3. Accordingly, compared to a case in which it is necessary to create a new program code for the portion pertaining to the output of the audio data A3, it is possible to increase the efficiency of development of the audio processing software Q.

### C: Modified Examples

Specific modified embodiments to be added to each of the embodiments exemplified above are illustrated below. Two or more embodiments arbitrarily selected from the following examples can be appropriately combined insofar as they are not mutually contradictory.

(1) A mode is also conceivable in which the extension processing unit 23 executes both the process of the first embodiment in which the sampling rate of the audio data A supplied from the audio data input unit 21 is converted and the process of the second embodiment in which the sampling rate of the audio data A output to the audio data output unit 24 is converted. That is, the first embodiment and the second embodiment can be combined.

For example, as shown in FIG. 5, the extension processing unit 23 converts the audio data A1 with the sampling rate Fa supplied from the audio data input unit 21 to the audio data A2 with the sampling rate Fb that can be processed by the audio processing unit 22. The audio processing unit 22 executes various types of audio processing on the audio data A2 that have been processed by the extension processing unit 23, thereby generating audio data A3 with the sampling rate Fb. The extension processing unit 23 converts the audio data A3 with the sampling rate Fb supplied from the audio processing unit 22 to audio data A4 with sampling rate Fc that can be output by the audio data output unit 24. The sampling rate Fb is different from the sampling rate Fc. The sampling rate Fc can be the same as or different from the sampling rate Fa.

As described above, the extension processing unit 23 of FIG. 5 executes the acquisition process S1 for acquiring, from the audio data input unit 21, the audio data A1 bypassing (i.e., without going through) the audio processing unit 22 (audio processing software Q), and the output process S3 for outputting the audio data A4 to the audio data output unit 24 bypassing (i.e., without going through) the audio processing unit 22 (audio processing software Q). Accordingly, the configuration of FIG. 5 realizes the same effects as those of the first embodiment and the second embodiment.

(2) In the embodiments described above, the sound collection device 13 is exemplified as the audio data input unit 21, but the configuration and operation of the audio data input unit 21 can be freely changed without being limited to the examples described above. For example, playback software that outputs samples of the audio data A1 in time series, or communication software that receives samples of the audio data A1 from an external device in time series, can be adopted as the audio data input unit 21. As illustrated above, the audio data input unit 21 is comprehensively expressed as a given audio interface serving as a supply source of the audio data A, and can be either software or hardware.

(3) In the embodiments described above, the sound output device 14 is exemplified as the audio data output unit 24, but the configuration and operation of the audio data output unit 24 can be freely changed without being limited to the examples described above. For example, recording software that stores samples of the audio data A3 in the storage device 12 in time series, or communication software that transmits samples of the audio data A3 to an external device in time series, can be adopted as the audio data output unit 24. As illustrated above, the audio data output unit 24 is comprehensively expressed as a given audio interface serving as an output destination of the audio data A, and can be either software or hardware.

(4) In the embodiments described above, the embodiment is illustrated in which the extension process S2 realized by the audio processing plug-in P includes a conversion process for converting the sampling rate of the audio data A, but the specific content of the extension process S2 can be freely changed without being limited to the example described above. For example, the audio processing mentioned above regarding the audio processing software Q (for example, effect imparting process, mixing process, mastering process, or recording process) can be included in the extension process S2 carried out by the audio processing plug-in P.

(5) As described above, the functions of the audio processing system 100 illustrated above are realized by cooperation between one or more processors that constitute the control device 11, and programs (audio processing software Q, audio processing plug-in P) stored in the storage device 12. The programs according to this disclosure can be provided in a form stored in a computer-readable storage medium and installed on a computer. The storage medium is, for example, a non-transitory storage medium, a good example of which is an optical storage medium (optical disc) such as a CD-ROM, but can include a storage medium of any form, such as a semiconductor storage medium or a magnetic storage medium. A non-transitory storage medium includes any storage medium that excludes transitory propagating signals and does not exclude volatile storage media. In addition, in a configuration in which a distribution device distributes the programs via a communication network, a storage device that stores the programs in the distribution device corresponds to the non-transitory storage medium described above.

### D: Addendum

For example, the following configurations can be understood from the embodiments exemplified above.

The audio processing method according to one aspect (first aspect) of this disclosure executes, by an audio processing plug-in that extends functions of audio processing software: an acquisition process for acquiring audio data from an audio data input unit bypassing (i.e., without going through) the audio processing software, an extension process for processing audio data acquired by the acquisition process, and an output process for outputting audio data after the extension process for processing by the audio processing software. In the embodiment described above, the acquisition process for acquiring audio data bypassing (i.e., without going through) the audio processing software, the extension process for processing audio data acquired by the acquisition process, and the output process for outputting the audio data after the extension process to the audio processing software, are realized by an audio processing plug-in that extends the functions of the audio processing software. Accordingly, the audio data input unit is not limited to an interface that is compatible with the audio processing software. That is, it is possible to relax the restrictions on the combination of the audio processing software and the audio data input unit.

In a specific example (second aspect) of first aspect, the extension process includes a conversion process for converting the sampling rate of audio data acquired by the acquisition process. According to the aspect described above, audio data with a sampling rate compatible with the audio data input unit can be converted to audio data with a sampling rate compatible with the audio processing software.

An audio processing method according to one aspect (third aspect) of this disclosure executes, by an audio processing plug-in that extends functions of audio processing software: an acquisition process for acquiring audio data from the audio processing software, an extension process for processing audio data acquired by the acquisition process, and an output process for outputting audio data after the extension process to an audio data output unit bypassing (i.e., without going through) the audio processing software. In the embodiment described above, the acquisition process for acquiring audio data bypassing (i.e., without going through) the audio processing software, the extension process for processing audio data acquired by the acquisition process, and the output process for outputting the audio data after the extension process to the audio processing software, are realized by an audio processing plug-in that extends the functions of the audio processing software. Accordingly, the audio data output unit is not limited to an interface that is compatible with the audio processing software. That is, it is possible to relax the restrictions on the combination of the audio processing software and the audio data output unit.

In a specific example (fourth aspect) of third aspect, the extension process includes a conversion process for converting the sampling rate of audio data acquired by the acquisition process. According to the aspect described above, audio data with a sampling rate compatible with the audio processing software can be converted to audio data with a sampling rate compatible with the audio data output unit.

An audio processing plug-in according to one aspect (fifth aspect) of this disclosure is an audio processing plug-in that extends functions of audio processing software that causes a computer system to execute: an acquisition process for acquiring audio data from an audio data input unit bypassing (i.e., without going through) the audio processing software, an extension process for processing audio data acquired by the acquisition process, and an output process for outputting audio data after the extension process for processing by the audio processing software.

An audio processing plug-in according to one aspect (sixth aspect) of this disclosure is an audio processing plug-in that extends functions of audio processing software that causes a computer system to execute: an acquisition process for acquiring audio data from the audio processing software, an extension process for processing audio data acquired by the acquisition process, and an output process for outputting audio data after the extension process to an audio data output unit bypassing (i.e., without going through) the audio processing software.

What is claimed is:

1. An audio processing method realized by a computer system, the audio processing method comprising:
acquiring, from an audio data input unit, audio data without going through an audio processing software;
performing an extension processing on the audio data that have been acquired; and
outputting the audio data on which the extension processing has been performed, for a processing by the audio processing software,
the acquiring, the performing of the extension processing, and the outputting being performed by executing an audio processing plug-in configured to extend a function of the audio processing software.

2. The sound processing method according to claim 1, wherein
the extension processing includes a conversion processing in which a sampling rate of the audio data that have been acquired is converted.

3. An audio processing method realized by a computer system, the audio processing method comprising:
acquiring audio data from an audio processing software;
performing an extension processing on the audio data that have been acquired; and
outputting the audio data on which the extension processing has been performed to an audio data output unit without going through the audio processing software,
the acquiring, the performing of the extension processing, and the outputting being performed by executing an audio processing plug-in configured to extend a function of the audio processing software.

4. The audio processing method recited in claim 3, wherein
the extension processing includes a conversion processing in which a sampling rate of audio data that have been acquired is converted.

5. An audio processing system comprising:
an electronic controller including one or a plurality of processors, the electronic controller being configured to, by executing an audio processing plug-in configured to extend a function of an audio processing software,
acquire, from an audio data input unit, audio data without going through the audio processing software,
perform an extension processing on the audio data that have been acquired, and
output the audio data on which the extension processing has been performed, for a processing by the audio processing software.

6. The audio processing system according to claim 5, wherein
the electronic controller is configured to, as the extension processing, convert a sampling rate of the audio data that have been acquired.

7. An audio processing system comprising:
an electronic controller including one or a plurality of processors, the electronic controller being configured to, by executing an audio processing plug-in configured to extend a function of an audio processing software,
acquire audio data from the audio processing software,
perform an extension processing on the audio data that have been acquired, and
output the audio data on which the extension processing has been performed to an audio data output unit without going through the audio processing software.

8. The audio processing system according to claim 7, wherein
the electronic controller is configured to, as the extension processing, convert a sampling rate of the audio data that have been acquired.
